(19) United States
(12) Patent Application Publication
(10) Pub. No.: US 2007/0112511 A1
(43) Pub. Date: May 17, 2007

(54) Mobile geo-temporal information manager

(75) Inventors: Craig Burfeind, Chanhassen, MN (US); Douglas P. Kruhoeffer, Eden Prairie, MN (US)

Correspondence Address: DIGITAL CYCLONE, INC.;c/o GARMIN INTERNATIONAL, INC., 1200 EAST 151ST STREET, ATTN: LEGAL - IP, OLATHE, KS, 66062, US

(73) Assignee: Digital Cyclone, Inc.

(21) Appl. No.: 11/281,836

(22) Filed: Nov. 17, 2005

(51) Int. Cl. G01C 21/00

(52) U.S. Cl. 701/213; 709/203; 340/989

(57) ABSTRACT

A geo-temporal information display system includes a wireless telecommunications device connected to a geo-temporal information server. The wireless telecommunications device includes a display. The geo-temporal information server contains geo-temporal information and at least one map. The map includes at least one particular location which, for example, may be the location if the telecommunications device. The telecommunications device receives a user-customized subset of the geo-temporal information. The subset may be a specific type of weather data, such as precipitation or lightning. The subset may also represent other geo-temporal information. This subset is displayed concurrently with the map on the display of the wireless telecommunications device.

### TECHNICAL FIELD

The present invention relates generally to client/server multimedia applications and more specifically to generation and distribution of multimedia event-based geo-temporal information to mobile devices.

### BACKGROUND

Natural-phenomenological data is collected almost instantaneously from numerous sources. For example, natural meteorological data is collected from a multitude of individual sites scattered across the world, such as airports. In another example, hydrological data is collected from nearly all of the rivers in the United States. Consumer interest in natural-phenomenological information has increased as a result of increased participation in outdoor activities and increasingly damaging natural phenomena, such as hurricanes, tornadoes, and floods.

Systems for electronic distribution of natural-phenomenological information are available. Such conventional systems typically include a computer software program running on a client computer that displays periodically reported natural-phenomenological information provided by the National Weather Service through a direct telephone line dial-up connection or an Internet connection. The natural-phenomenological information conventionally includes, past, present, and forecast meteorological conditions for a number of specific geographic locations including, for example, meteorological measures of temperature, relative humidity, wind direction and speed, barometric pressure, wind chill, dew point, precipitation activity, cloud coverage, satellite images, radar images, aviation-related information, warnings and watches of dangerous natural phenomena such as floods, tornadoes, hurricanes, lightning, hail size, speed and direction of the movement of storm cells, wind gusts within storm cells, supercell type, avalanches, brush fires, and forecasts for the local geographic area and the geographic region. Natural-phenomenological information also includes tide cycles, hydrological measures of lakes and rivers, seismological reports and forecasts, and ski area snow condition reports, and cosmological events such as sunrise, sunset, and moon phases.

The software programs that display the information include widely available browsers, platform independent applets, or custom-programmed graphical user interfaces. Server processes are implemented to support the distribution of information to client computers.

Consumers of natural-phenomenological information typically are interested only in a portion of the large amount of natural-phenomenological information that is available. The process of filtering through the large amount of natural-phenomenological information in order to retrieve the specific information that the consumer is interested in and performing a manual qualitative analysis of the information is difficult and inefficient for the consumer. For example, leisure sailors may be primarily interested in wind and tide conditions and golfers may be primarily interested in lightning, precipitation, and sun intensity. Non-commercial pilots may be particularly interested in conditions at altitudes that few others are interested in. Furthermore, people with particular health conditions may be primarily interested in ozone measurements and pollen count. Skiers may be specifically interested in ski conditions and avalanche reports and campers may be only interested in brush fire reports. Other individuals may only be interested in seismological information. People who work outdoors may be particularly interested in heat index and wind chill.

A person traveling to one or more locations during a period of time, such as outdoor sporting events or other activities, may be concerned by pending weather events that may occur during their planned activities at that location. An example of this may be a golfer who wants to know if lightning has struck nearby. It is also useful for the person to know how far away the weather event is from their current location. It is cumbersome to enter location data and locate the relevant weather event history. Once location and preference information is entered, the weather event information is often general and/or forecast-related rather than including recent weather events, such as lightning.

For these and other reasons, improvements are desirable.

### SUMMARY

In accordance with the present invention, the above and other problems are solved by the following:

In one aspect, the present disclosure describes a geo-temporal information display system. The system includes a wireless telecommunications device connected to a geo-temporal information server. The wireless telecommunications device includes a display. The geo-temporal information server contains geo-temporal information and at least one map. The map includes at least one particular location which, for example, may be the location of the telecommunications device. The telecommunications device receives a user-customized subset of the geo-temporal information. The subset may be a specific type of weather data, such as precipitation or lightning. The subset may also represent other geo-temporal information. This subset is displayed concurrently with the map on the display of the wireless telecommunications device.

In another aspect, a method of displaying geo-temporal information is disclosed. The method includes determining a particular location of the mobile telecommunications device. The method further includes selecting at least one user-customized subset of geo-temporal information stored on a geo-temporal information server. The method includes generating a request for geo-temporal information associated with the particular location of the mobile telecommunications device. The method includes receiving a map configured to present geographical information on the display. The method includes receiving map data and geo-temporal information on the mobile telecommunications device. The method further includes presenting the subset with the map on the display of the telecommunications device. The map includes the particular location.

In a further aspect, a mobile telecommunications device having a graphical user interface including a display and a user interface selection device is disclosed performing the method described above.

In yet another aspect, an emergency weather event graphical display system is disclosed. The weather event display system includes a mobile telecommunications device, which has a display. The telecommunications device is wirelessly connected to a weather information server that contains emergency weather event information. The emergency weather event information represents emergency weather events, such as lightning, tornadoes, or other events that occurred within a predetermined time. The system further includes a map stored on the server that is configured to present geographical information on the display of the telecommunications device. The geographical information represents an area that includes the current location of the telecommunications device. The system further includes first and second graphical objects configured for display, the graphical objects representing emergency weather events. The first graphical object represents a recent weather event, and the second graphical object represents weather events that have happened in the recent past. This weather information, including the graphical objects, is presented on the display concurrently with the map.

In a further aspect, a method of displaying server-generated lightning alerts is disclosed. The method further includes determining a current location of the mobile telecommunication device. The method also includes receiving in the telecommunications device a lightning alert generated by a weather information server. The method also includes presenting a lightning message on the display. The lightning alert corresponds to a lightning event occurrence within a predetermined proximity to the current location of the telecommunications device.

In yet another aspect, a current weather monitor for a mobile telecommunications device is disclosed. The monitor resides on a mobile telecommunications device that has a color display. A selected graphic is presented on the display, such as a default menu. An icon containing temperature and a weather status indicator denoting the existence of a weather warning is incorporated into the graphic.

### BRIEF DESCRIPTION OF THE DRAWINGS

FIG. 1 is a block diagram of a geo-temporal information display system;

FIG. 2 is a schematic representation of a computing system that may be used to implement aspects of the present disclosure;

FIG. 3 is a logical flow diagram of an information system that displays geo-temporal information, performed in reference to a location of the mobile telecommunications device, according to an example embodiment of the present disclosure;

FIG. 4 is an emergency weather event graphical display system according to an example embodiment of the present disclosure;

FIG. 5 is a weather system that gives server-generated weather alerts, such as lightning alerts according to an example embodiment of the present disclosure;

FIG. 6 is a block diagram of a computerized server system for serving requests for geo-temporal information, in reference to an event, according to an embodiment of the disclosure;

FIG. 7 is a current weather monitor for a mobile telecommunications device according to an embodiment of the disclosure;

FIG. 8 is a feature diagram of a geo-temporal information server incorporating weather data according to an embodiment of the disclosure;

FIG. 9 is a feature diagram of a geo-temporal information server incorporating graphical features according to an embodiment of the disclosure;

FIG. 10 is a feature diagram of a geo-temporal information server incorporating storm watch features according to an embodiment of the disclosure.

### DETAILED DESCRIPTION

The present disclosure discusses a mobile geo-temporal information manager. Although a number of embodiments are discussed, these are not meant to limit the scope of the invention, which is presented in the claims. First the disclosure is discussed generally, following with a description of the drawings and interrelations of the structures included to provide the mobile geo-temporal information manager disclosed.

The present disclosure describes a geo-temporal information display system. The system includes a wireless telecommunications device that includes a display, and is connected to a geo-temporal information server. The geo-temporal information server contains geo-temporal information and at least one map. The map includes at least one location which, for example, may be the location if the telecommunications device. The telecommunications device receives a user-customized subset of the geo-temporal information. The subset of information may be a specific type of weather data, such as precipitation or lightning. The subset may also represent other geo-temporal information, such as earthquakes, floods, or other events. The chosen subset is displayed concurrently with the map on the display of the wireless telecommunications device.

A method of displaying geo-temporal information is also disclosed. The method includes determining a particular location of the mobile telecommunications device. The location could be, for example, the current location of the device. The method further includes selecting at least one user-customized subset of geo-temporal information stored on a geo-temporal information server. The method includes generating a request for geo-temporal information associated with the particular location of the mobile telecommunications device. The method includes receiving a map configured to present geographical information on the display. The method includes receiving map data and geo-temporal information on the mobile telecommunications device. The method further includes presenting the subset with the map on the display of the telecommunications device, where the map includes the particular location. The wireless telecommunications device may include a graphical user interface performing the method.

An emergency weather event graphical display system is also illustrated in the present disclosure. The weather event display system includes a mobile telecommunications device, which has a display. The telecommunications device is wirelessly connected to a weather information server that contains emergency weather event information. The emergency weather event information represents emergency weather events, such as lightning, tornadoes, or other events that occurred within a predetermined time. The system further includes a map stored on the server that is configured to present geographical information on the display of the telecommunications device. The geographical information represents an area that includes the current location of the telecommunications device. The system further includes first and second graphical objects configured for display, the graphical objects representing emergency weather events. The first graphical object represents a recent weather event, and the second graphical object represents weather events that have happened in the recent past. This weather information, including the graphical objects, is presented on the display concurrently with the map. In this way, current and recent occurrences of severe weather, such as lightning strikes, can be displayed. The current and recently occurred weather events can be distinguished by differences in appearance, such as a changed color.

A method of displaying server-generated lightning messages is also disclosed. The method includes determining a current location of the mobile telecommunication device. The method also includes receiving in the telecommunications device a lightning message generated by a weather information server. The method also includes presenting a lightning message on the display. The lightning message corresponds to a lightning event occurrence within a predetermined proximity to the current location of the telecommunications device.

Further, a current weather monitor for a mobile telecommunications device is disclosed. The monitor resides on a mobile telecommunications device that has a color display. A selected graphic is presented on the display, such as a default menu. An icon containing temperature and a weather status indicator denoting the existence of a weather warning is incorporated into the graphic. In this way, the basic weather information corresponding to a given location can be displayed concurrently with other graphics on the display of the telecommunications device.

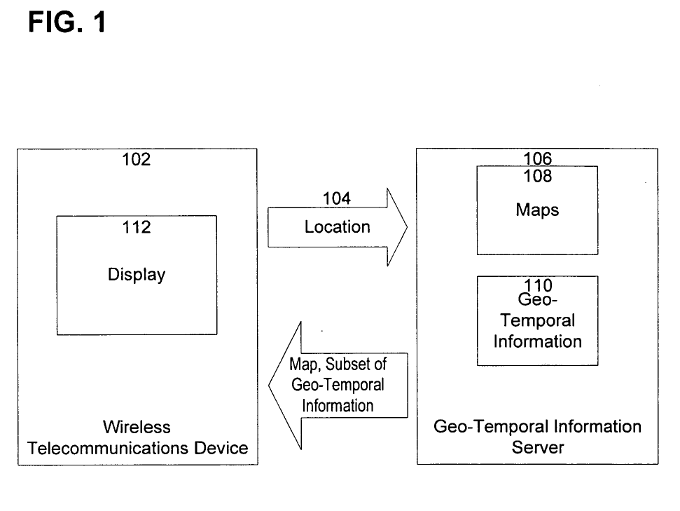

Referring to FIG. 1, a block diagram of a geo-temporal information display system 100 is disclosed. The system 100 includes a mobile telecommunications device 102 that accesses a geo-temporal information server 106 in reference to the location 104 and time of an event. The telecommunications device 102 requests the retrieval of the geo-temporal information 110 from the geo-temporal information server 106. Of course, the geo-temporal information server 106 could push the information to the telecommunications device 102.

The geo-temporal information server 106 provides geo-temporal information and maps 108 configured for presentation on a display 112 of the mobile telecommunications device 102. The maps 108 might be stored and transmitted to the mobile telecommunications device 102 in a variety of formats, such as JPG, bitmap, GIF, TIFF, or other formats recognizable by the mobile telecommunications device 102. The maps 108 might also include animation, and be sent to the device as either a series of graphical representations in these formats or as a movie file, such as a MOV, AVI, or MPEG file.

The present disclosure enables access to geo-temporal information 110 in reference to the location 104 and time of an event, for the convenience of the user, preferably, in which the user does not need to indicate the location such as by typing or selecting the zip code or city of the location.

In examples of the present disclosure, the geo-temporal information 110 might be a wide variety of types of weather or natural occurrence event data. For example, the geo-temporal information may be rainstorm location and severity information, snow depth information, ultraviolet radiation level information, lightning time and location information, or forecast information. Additionally, information regarding the severity of the event, its projected path of travel, and/or its estimated arrival time may be displayed. For example, the estimated time of arrival of a rainstorm or tornado may be displayed along with rainstorm data. Counties on the map may be color-coded based on the severity of a threat of natural events occurring in the area, and may blink in the case of emergencies. Radar or cloud cover data may be included in the display. The map and associated geo-temporal event information display might be three-dimensional or it may be navigable. This provides a look similar to weather forecasts provided on television that will be familiar to users.

Sources of geo-temporal data stored on or accessible to the geo-temporal information server may include radar data records, satellite data records, gridded natural-phenomenological records, and raw natural-phenomenological records in various embodiments of the disclosure. The National Weather Service (NWS) of the National Oceanic and Atmospheric Administration (NOAA) is one of many organizations that are sources for this information. Radar text records provide data regarding current precipitation. Satellite data records provide data regarding current cloud cover. Gridded natural-phenomenological records provide numerical measurement data on current conditions at a variety of altitudes and locations. Raw natural-phenomenological records provide numerical ground observation measurement data on current conditions.

In one embodiment, radar data records are implemented on the geo-temporal information server. The radar data records include data on current precipitation. In another embodiment, satellite data records are implemented. The satellite data records include data on clouds. In yet another embodiment, gridded natural-phenomenological records are implemented using gridded binary (GRIB) format. More specifically, the GRIB data is formatted according to a code form FM 94 binary universal form for the representation for natural-phenomenological data (BUFR), as published by the National Centers for Environmental Prediction (NCEP) of the National Weather Service of the National Oceanic and Atmospheric Administration of the U.S. Department of Commerce, titled “The WMO Format for the Storage of Weather Product Information and the Exchange of Weather Product Messages in Gridded Binary Form as used by the NCEP Central Operation,” author Clifford H. Dey, Mar. 10, 1998.

In still another embodiment, the geo-temporal information server contains raw natural-phenomenological records such as METAR data records, which are hourly ground natural-phenomenological observations. (The METAR acronym roughly translates from French as Aviation Routine Weather Report.) METAR data can be either METAR/SPECI or METAR/TAF. METAR is the international standard code format for hourly surface natural-phenomenological observations. The U.S. METAR code is described in Federal Weather Handbook (FMH) No.1 I“Surface Observations and Reports.” A special report, METAR/SPECI, is merely a METAR formatted report that is issued on a non-routine basis as dictated by changing natural-phenomenological conditions. (The SPECI acronym roughly translates as Aviation Selected Special Weather Report.) METAR/TAF is the international standard code format for terminal forecasts issued for airports. (The TAF acronym translates to Aerodrome Forecast.)

In a further example of the present disclosure, prerecorded audio messages may be included with the graphical representation of the geo-temporal event information. For example, a weather forecast could be voice-recorded and played along with a display of precipitation radar data. Alternately, descriptions of current weather events could be recorded and played concurrently with the displayed message.

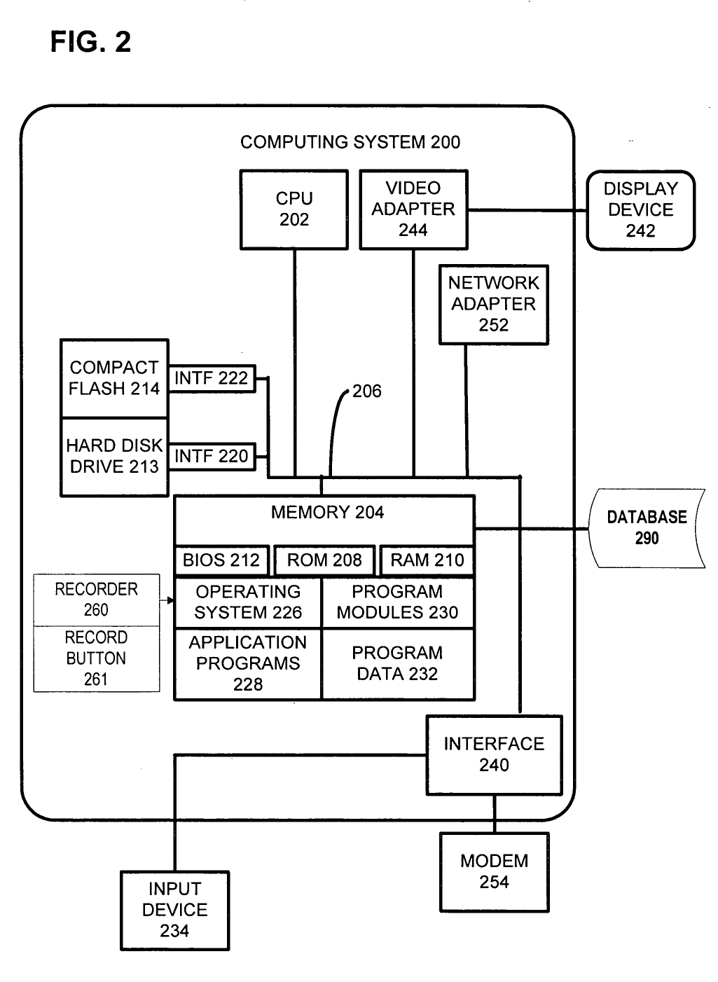

Embodiments of the present disclosure are described as utilizing a wireless telecommunication device, such as a cellular telephone, personal digital assistant, or other “convergence” products commonly available. Such devices are capable of wireless communication with data sources such as a server, one example of which is described in FIG. 2, below. Such wireless communication is generally facilitated by the service provider of the product used. Common wireless providers include Verizon Wireless, Sprint/Nextel, Cingular Wireless, and others.

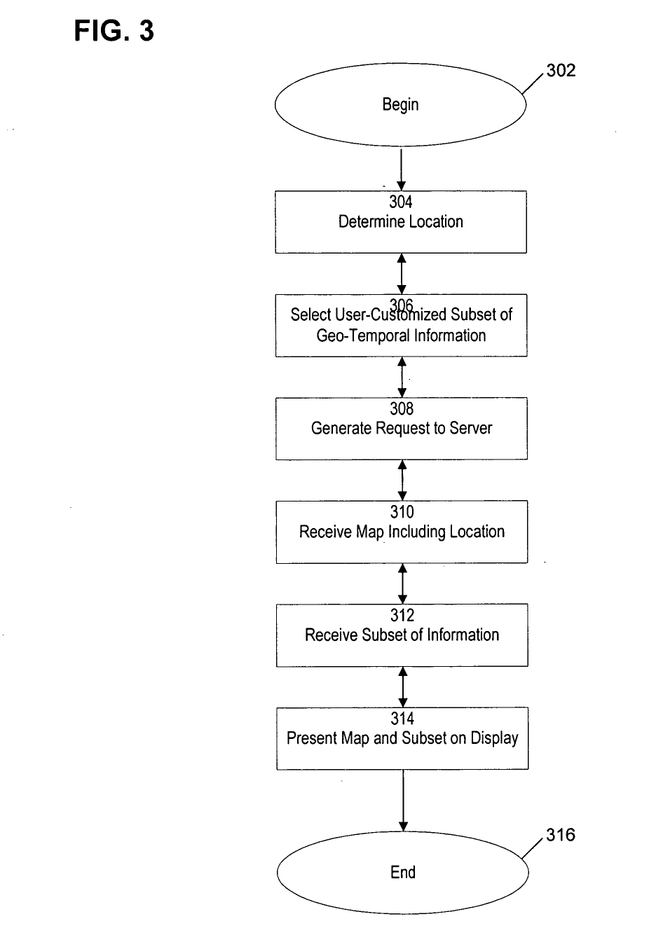

Further embodiments of this disclosure describe a map containing a particular location. The particular location may be the current location of the mobile telecommunication device, or may be a previously saved location of the mobile telecommunication device. The particular location may also be based on periodic updating of the current location to determine a path of travel, and present geo-temporal information based on extrapolated locations where the device will be at a given time in the near future. These locations are determined automatically by the telecommunications device, the service provider, or a combination of the two. An example of such location determinations are described in the method of FIG. 3, below.

If the particular location is a previously saved location, the system described in the present disclosure updates the weather data displayed on the telecommunications device only when a request is sent from the device. If the particular location is the current location of the device, the user has the option to preset periodic updates to the telecommunications device. This allows the user to stay updated on the current weather conditions at the location of the telecommunications device as the user and device travel from one location to another.

Due to the broad possibilities for wireless communication and dependence on service providers, this disclosure is not limited to any particular telecommunications device 102, location 104, geo-temporal information 110, or geo-temporal information server 106 or combination thereof.

Referring now to FIG. 2, an exemplary environment for implementing embodiments of the present disclosure includes a general purpose-computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Computing system 200 also has at least one operating environment running thereon, each desirably providing a graphical user interface including a user-controllable pointer. Such operating environments include operating systems such as versions of the Microsoft Windows and Apple MacOS operating systems well-known in the art. The disclosure is not limited to any particular operating environment, however, and the construction and use of such operating environments are well known within the art. Computing system 200 also desirably can have at least one web browser application program running within at least one operating environment, to permit users of computing system 200 to access intranet or Internet world-wide-web pages as addressed by Universal Resource Locator (URL) addresses. Such browser application programs include Netscape Navigator and Microsoft Internet Explorer.

FIG. 3 is a logical flow diagram of an information system 300 that displays geo-temporal information, performed in reference to a location of the mobile telecommunications device, according to an example embodiment of the present disclosure. This method may be implemented using a mobile telecommunications device having a graphical user interface including a display and a user interface selection device. The mobile telecommunications device may be a cellular phone, personal digital assistant, or other wireless-capable device.

The information system 300 enables a user to access geographic information in reference to the current physical location of the device. The information system 300 also enables a user to access natural-phenomenological information other than merely weather information. In addition, the information system 300 enables a user to access geographical information in reference to a time other than current weather conditions or weather forecast of unspecified time duration or time. The user is able to access geographical information related to a particular time or a time period in the future.

The information system 300 is instantiated by a begin operation 302.

A location operation 304 determines the location of the mobile telecommunications device. The location can be a past, present, or future location. Past locations are saved on a geo-temporal information server, while present locations may be determined using a variety of methods. Near future locations may be extrapolated from present and past locations, for example if the mobile telecommunications device is in transit. Hence, all locations are at one time calculated as present physical locations.

Determining the present physical location of a mobile telecommunications device may be accomplished in a variety of ways consistent with the present disclosure. In one example, determining a current physical location of an electronic device includes sending a request for an indication of the proximate or specific, current location of the electronic device to a server and receiving the indication of the location of the mobile telecommunications device from the server.

In another example of locating the mobile telecommunications device, the server is a component of a service provider of the electronic device. The service provider of the wireless digital assistant device has access to information regarding the nearest transmission/reception base stations communicating with the device. Knowing the speed of transmission of the electromagnetic waves used for the communication, it is straightforward for the device or service provider to extrapolate a location of the device based on its distance from at least three communication base stations using a triangulation method. The distance to the device may be determined by measuring the relative time delays in the signal from the device to the three different base stations.

In another example, a global positioning system (GPS) is used to determine the current physical location of the mobile telecommunications device. The GPS system ensures that at least four satellites are above the horizon at any given point on earth. Each satellite tracks its own position and time and continually broadcasts this information in terms of a uniform time and latitude/longitude. Devices containing a GPS receiver receive this information. This information can be transmitted to the service provider, which can use the latitude, longitude, and timestamp information to compute the location of the device relative to the satellites in the form of latitude and longitude information.

Alternately, the device may be capable of computing its location independently of the service provider. Regardless of where this information is computed, it is communicated to the device. If the device is moving, its receiver may also be able to calculate speed and direction of travel based on the rate that the latitude and longitude coordinates change. This allows the GPS system to give estimated times of arrival at specified destinations.

In yet another example, where a mobile telecommunications device is a Palm series personal digital assistant, communication with the service provider is implemented using the Palm Query Application (PQA) format. A location-related keyword, such as “zipcode” is transmitted from the Palm to the service provider in PQA format, the keyword is translated by the service provider, and the value of the zip code of the nearest base station to the Palm is returned. The distance between the Palm and the nearest base station is usually within five to ten miles.

A selection operation 306 selects at least one user-customized subset of geo-temporal information stored on a geo-temporal information server. An initial preference selection can be done once initially, and changed at any time by a user. This involves the user selecting specific types of geo-temporal events for which the user is interested. After this is done, the selection operation 306 selects the preferred geo-temporal event information from among the wide range of geo-temporal information residing on the server. This can be accomplished by storing the user preferences on the mobile telecommunications device or by storing user preferences in an accounts database on the server (not shown).

A request operation 308 generates a request for geo-temporal information associated with the location, determined by the determine operation 304 along with the current time. For convenience, the request operation 308 can also be associated with a predetermined list of physical locations, allowing for one request and multiple location references.

In varying examples, the geo-temporal information includes road conditions, road traffic, weather information, hurricane information, tornado information, flood information, and/or geologic-activity information such as weather information only, or geo-temporal information selected from the group consisting of weather information, hurricane information, tornado information, flood information, and geologic-activity information. One example of geologic-activity information is volcanic-activity information.

In one example, the request operation 308 can generate a request that includes a destination address that directly identifies a geo-temporal information source. The direct addressing of the destination provides for a request on which intermediate components in the transmission are transparent to the requesting component that hosts the information system 300. For example, where the component that hosts the information system 300 is a client operatively coupled to the Internet, and the destination address specifies a source of geo-temporal information that is also operatively coupled to the Internet, the servers on the Internet that store and forward the request are transparent to the requesting component that hosts the information system 300. In varying examples, the destination address in the request includes an Internet Protocol destination address, a Universal Resource Indicator (URI) address, and/or a Universal Resource Locator (URL) address.

A map operation 310 receives a map configured to present geographical information on the display of the mobile telecommunications device. The map comprises a graphical representation of the particular location as determined above.

A receive operation 312 receives subset data relevant to the current time and the determined location of the mobile telecommunications device. The subset data may be weather data, such as precipitation, lightning, tornado, or snowfall data. The data may also, for example, be geo-temporal information, such as ultraviolet radiation levels or temperature data.

The map operation 310 and the receive operation 312 can occur simultaneously, or the map and subset data may alternately be merged by a geo-temporal information server, such as the server 106 in FIG. 1, and received as a single set of information.

A present operation 314 presents the map data and the user-customized subset data on the display of the mobile telecommunications device. In one example, the geo-temporal information is also output through a speech-synthesis unit associated with the mobile telecommunications device. This display may include animation or time-lapse images of the geo-thermal weather events, enabling the mobile telecommunication device to track the path of travel of the events. The display may be navigable, allowing the user to look at other areas of the map using function keys of the mobile telecommunications device.

The information system terminates with an end operation 316.

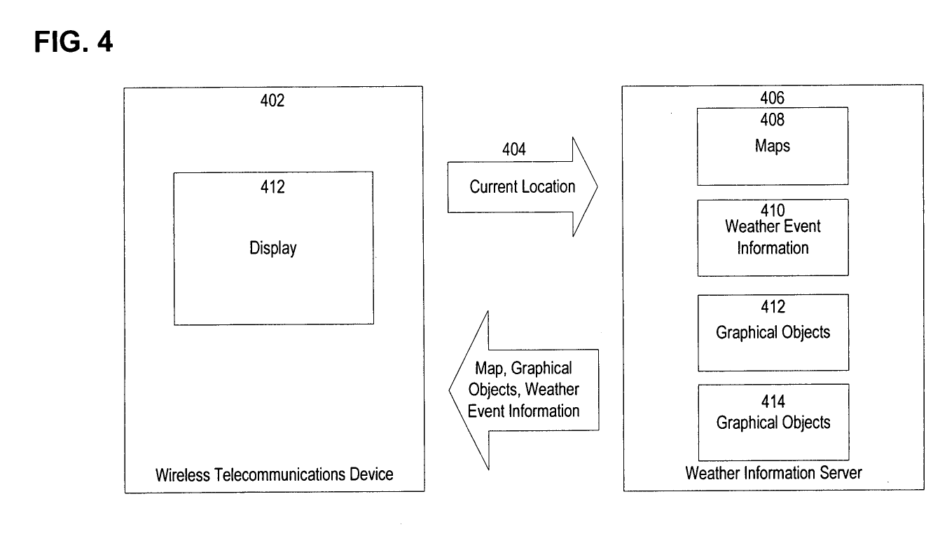

FIG. 4 shows an emergency weather event graphical display system 400 according to an example embodiment of the present disclosure. The system 400 includes a mobile telecommunications device 402 that accesses a geo-temporal information server 406 in reference to the current time and the current location of the mobile telecommunications device 402. The electronic device 402 requests the retrieval of the weather event information 410 from the weather event information server 406. In one example, the weather event information server can be a computing system, such as the computing system 200 of FIG. 2.

The present disclosure enables access to weather event information 410 in reference to the location 412 and time of an event, for the convenience of the user, in which the user does not need to indicate the location, such as by typing or selecting the zip code or city of the location. The server 406 includes at least one map 408 configured to present geographical information on the display 412 of the wireless computing device 402. These values are changed by periodically updating the current location 412 of the mobile telecommunications device 402. Preferably, the map 408 and weather event information 410 are updated periodically based on user settings. The telecommunications device 402 receives push messages from the weather event information server 406 as desired by the user.

By the term “push” it is meant that the information server 406 transmits to the device 402 without receiving a request from the device 402. This is in contrast to a “pull” system, where the information server 406 transmits to the device 402 in response to a request from the device 402.

The system includes first and second graphical objects 412, 414, each with distinct appearances. The first graphical object 412 displays recent weather events, and the second graphical object 414 displays historical weather events. For example, the graphical objects 414 could appear as lightning strikes to signify where lightning has recently hit. The lightning strikes that are most recent could be white, signifying they are of more significance, whereas the less recent and more historical lightning strikes may be yellow or another color signifying less importance.

In examples of the present disclosure, the weather event information 410 may be a wide variety of types of weather events. For example, the weather event information may be lightning time and location information, tornado information, hurricane information, or other emergency events. Additionally, information regarding the severity of the event, its projected path of travel, and/or its estimated arrival time may be displayed. For example, the estimated time of arrival of a tornado may be displayed along with past occurrence data.

Further embodiments of this disclosure describe a map containing a current location of the mobile telecommunications device 402. The current location may be determined by any of the previously discussed methods, or other methods suited to mobile, wireless communication.

Due to the broad possibilities for wireless communication and dependence on service providers, this disclosure is not limited to any particular telecommunications device 402, location 404, weather event information 410, graphics 412, 414, weather event information server 406, or any combination thereof.

Using various embodiments described, a user can set specific weather events regarding that which the user is interested in receiving alerts. These preferences can be stored on a weather event information server 410. For example, a golfer could choose to select lightning alerts. When the weather event server 410 detects lightning, it would “push” a message to the telecommunications device 402.

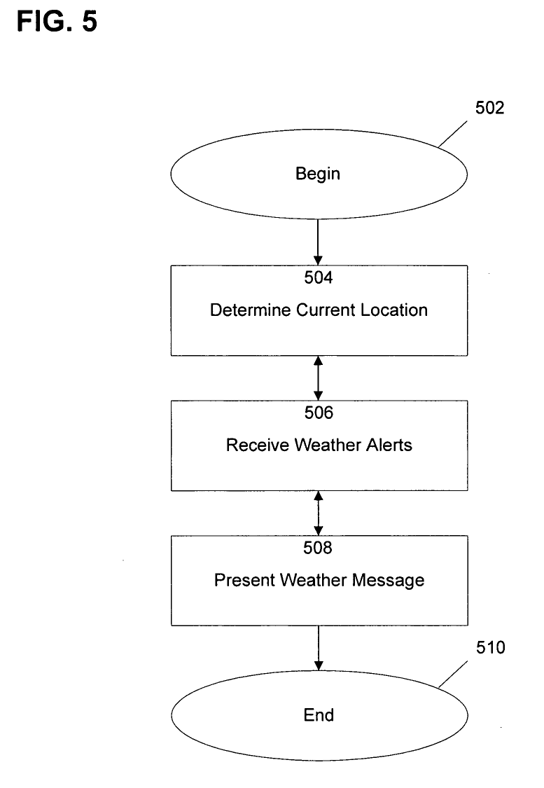

Referring to FIG. 5, a weather system 500 that gives server-generated weather alerts, such as lightning messages is described according to a possible example embodiment of the present disclosure. In general, the weather system 500 provides alerts sent from a server to a mobile telecommunications device without the need for the user to continually check for inclement weather.

The weather system 500 is instantiated by a begin operation 502.

A location operation 504 determines the current location of the mobile telecommunications device. This can be accomplished according to any of the appropriate methods described herein.

A receive operation 506 receives a weather alert, such as a lightning alert, generated by a weather information server. Preferably, the weather alert corresponds to detection of severe weather, such as lightning, within a predetermined distance from the current location of the mobile telecommunications device. For example, a first lightning alert within 20 miles would generate a first alert message that would be received on the mobile telecommunications device. Subsequent lightning strikes could cause separate messages, or alternately, only a subsequent lightning strike within a second threshold, such as 5 miles, would cause a second message. The weather system 500 could require multiple lightning strikes to be detected before an alert message is sent, depending on, for example, sensitivity and error rates of the detection equipment.

A present operation 508 presents the several weather alert, or message, such as a lightning message received on the display of the telecommunications device. The lightning message may include, for example, a graphical image showing the location of the lightning strike with respect to the current location of the mobile telecommunications device. This graphical image may also be a radar image or a satellite image. The lightning message may be overlaid on a radar or satellite image. The message may also include a reference, such as a hyperlink, to corresponding weather information such as additional radar or satellite maps.

The message could also be an animation. For example, a looping image showing individual lightning strikes. The lightning strikes could be color coded according to time. For example, the latest strikes would be in white, followed by earlier strikes in yellow, and others in red. The message could also show real time lightning, for example, using data streaming.

A severe weather tracker could be incorporated. For example, a single image showing current satellite imagery with a red or other brightly colored forecast storm path. The path would have icons at projected positions along with the labeled forecast time.

Another feature would include a storm watch capability. The storm watch feature could include a map having color coded counties and a high threat area displayed. The path of the storm could be illuminated with a large arrow, along with the user's current location displayed. In addition, severe weather safety tips could be sent to the user's device. Severe weather watches and warnings could be sent.

Of course, information does not need to be displayed on the device. The present operation 508 could sound an alert, for example a specific sound or song set by the user, instead of displaying an alert. Preferably, the user could select different sounds for different types of alerts. The present operation 508 could sound an alert and display an alert.

The weather system is terminated with an end operation 510.

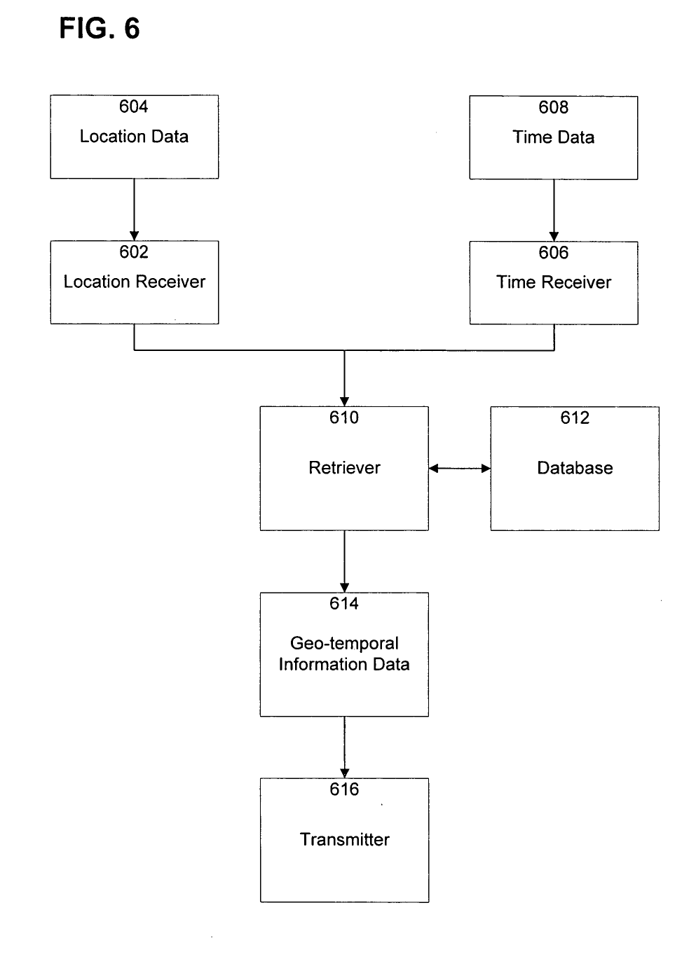

FIG. 6 is a block diagram of a computerized server system 600 for serving requests for geo-temporal information, in reference to an event, according to an example embodiment of the present disclosure. The server system 600 enables access to geo-temporal information of an event, and disclosure herein is meant to clarify the operation of a server request as discussed above.

The server system 600 includes a location receiver 602 of location data 604. The location data 604 is determined by a client in reference to an event. The server system 600 also includes a time receiver 606 of time data 608 in reference to the same event. The time period is determined by a client in reference to the event.

In one possible embodiment of the server system 600, the location receiver 602 and the time receiver 606 are embodied in one singular component (not shown) that receives a singular transmission. Examples of such a transmission include an object message, a function invocation, and a request. One example of a request is the request generated in system 300 of FIG. 3, above. A request may be implemented as a hyper-text transfer protocol (HTTP) request. The request includes an address of an electronic device (not shown) that is designated to receive geo-temporal information.

A retriever 610 gathers geo-temporal information from a database 612 of geo-temporal information in reference to the location data 604 and the time data 608. Responsive geo-temporal information data 614 is created.

The server system 600 also optionally includes a transmitter 616 that transmits the geo-temporal information 614 to the electronic device (not shown) that is designated to receive the geo-temporal information 614.

Embodiments of the location identifier, embodiments of the time period, embodiments of the request, embodiments of the destination address of the request, embodiments of the request for periodic transmission of one or more forecasts, and the various embodiments described above are available to the server system 600.

Another server system, not shown, provides access to geo-temporal information. The system includes a receiver of a request for geo-temporal information. The geo-temporal information is associated with a predetermined list of physical locations that is stored locally to the server. The geo-temporal information includes natural-phenomenological information, road condition information, and traffic condition information. The request is received from a client system, such as any one of the client system of the present disclosure. The list has at least one entry. The server system also includes a retriever of the geo-temporal information that is associated with each of the at least one entry of the predetermined list of physical locations. The retriever retrieves the geo-temporal information associated with each of the entries of the predetermined list of physical locations. The server system also includes a transmitter of the retrieved geo-temporal information.

The components of the system of the present disclosure can be embodied as computer hardware circuitry or as a computer-readable program, or a combination of both. In another embodiment, the system is implemented in an application service provider (ASP) system.

More specifically, in the computer-readable program embodiment, the programs can be structured in an object-orientation using an object-oriented language such as Java, Smalltalk, or C++, and/or the programs can be structured in a procedural-orientation using a procedural language such as COBOL or C. The software components communicate in any of a number of means that are well known to those skilled in the art, such as application program interface (API) or interprocess communication techniques such as remote procedure call (RPC), common object request broker architecture (CORBA), Component Object Model (COM), Distributed Component Object Model (DCOM), Distributed System Object Model (DSOM), and Remote Method Invocation (RMI). The components execute on as few as one computer such as computing system 200 in FIG. 2, or on at least as many computers as there are components.

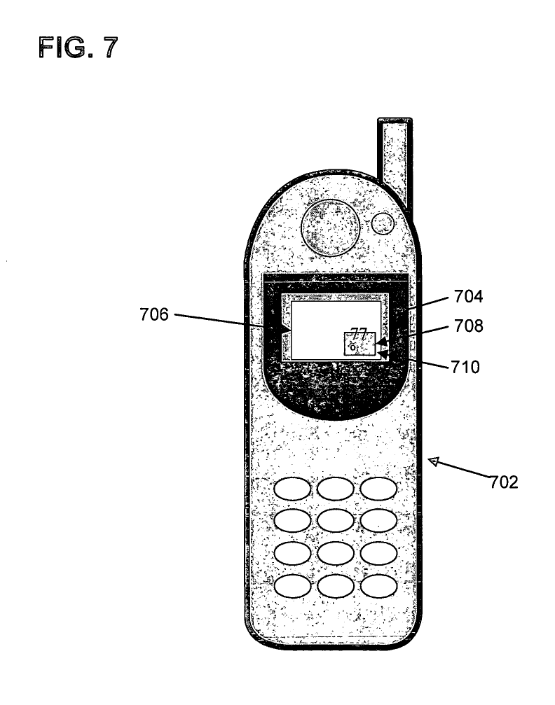

Referring to FIG. 7, a current weather device 700 for a mobile telecommunications device is shown for one possible example embodiment according to the present disclosure. The device 700 is embodied on a mobile telecommunications device, such as cellular phone 702. The device 700 could also be used in conjunction with other telecommunication devices such as personal digital assistants (PDAs) or “convergence” products that include attributes of both PDAs and cellular phones.

In this example embodiment, the device 700 uses a phone 702 that has a color display 704. For example, the color display 704 might be the main display of a cellular phone or a PDA, or might also be the secondary display of a folding cellular phone, or “flip-phone”. The color display includes a default graphic 706. The default graphic 706 may be, for example, the default menu or graphic shown while the device is on. The default graphic 706 includes an icon 708 that comprises a region of the display. The icon 708 presents a current temperature reading and a weather status indicator 710. The weather status indicator 710 can comprise a series of visual appearances denoting the existence of severe weather detected in the area. The visual appearances might, for example, be colors. Both the current temperature and visual appearance are updated using a geo-temporal information server such as the one described above. Preferably, the current weather device 700 utilizes the “push” technology available to such a server.

The device 700 can include a wake-up alarm feature, common to such devices. As disclosed herein, the device 700 could display or alert the user to the current weather or forecasted weather at the time of the wake-up alarm feature.

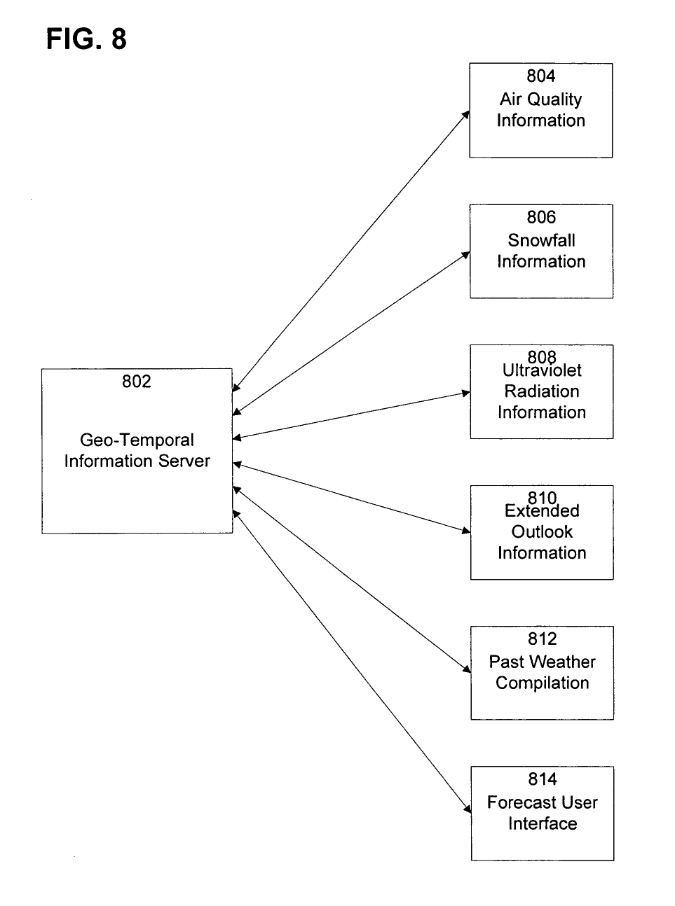

Referring to FIG. 8, a feature diagram 800 of a geo-temporal information server 802 incorporating weather data is shown according to an embodiment of the present disclosure. The weather data can include air quality information 804, snowfall information 806, ultraviolet radiation information 808, extended outlook information 810, past weather compilation 812, and a forecast user interface 814.

Air quality information 804 may include both current and predicted air quality for a given location. Local Pollution Control agencies around the USA release an Air Quality Index on a scale from 1 to 500. The Air Quality Index (AQI) was developed by the U.S. Environmental Protection Agency (EPA) to provide a simple, uniform way to report daily air quality conditions. The AQI is determined by measuring four pollutants: ozone, sulfur dioxide (SO2), fine particulate matter (PM2.5), and carbon monoxide. Local Pollution Control Agencies around the U.S. take hourly measurements of these pollutants at air quality sites located in each state. Ozone levels, which are only elevated in warm weather, are measured from April through September in northern latitude states, but year-round in warmer, southern climates. The AQI translates each pollutant measurement to a common index, with an index of 100 used to reflect where health effects might be expected in “sensitive populations.” An AQI value of 100 generally corresponds to the National Ambient Air Quality Standard for the pollutant, which is the level the EPA has set to protect public health. The pollutant with the highest index value is used to determine the overall AQI. The AQI uses numbers from 0 to 500 to describe the air quality conditions and their possible effects on human health. Readings of 0-50 are described as Good, 51-100 as Moderate, 101-150 as Unhealthy for Sensitive Groups, 151-200 as Unhealthy, 201-300 as Very Unhealthy, and 301 and above as Hazardous. In addition to current air quality assessments, forecasts of air quality are prepared by the U.S. Environmental Protection Agency's Office of Air Quality Planning and Standards.

The four pollutants incorporated into the AQI (ozone, sulfur dioxide, fine particulate matter, and carbon monoxide) as well as pollen comprise the major air pollutants affecting health on a day-to-day basis.

Ground-level ozone is formed in the atmosphere when nitrogen oxides and volatile organic compounds react in the presence of heat and sunlight. Cars, trucks, power plants, and solvents contribute to the formation of ozone, which is a major component of smog. Ozone can be transported into an area from sources hundreds of miles upwind. It is irritating to the eyes, nose, throat and lungs, and it can worsen the symptoms of asthma. The elderly, children, and people with respiratory illnesses are most at risk. Ozone can also damage plants, including crops and trees.

Sulfur dioxide is a heavy, pungent, colorless gas formed primarily by the combustion of coal, oil, and diesel fuels. Elevated levels can impair breathing, lead to other respiratory symptoms, and at very high levels aggravate heart disease. People with asthma are most at risk. Sulfur dioxide also contributes to acid rain, which can damage plants, lakes and buildings.

Fine particulate matter is a complex mixture of very small liquid droplets or solid particles in the air. Major sources are cars, trucks, construction equipment, coal-fired power plants, wood burning, vegetation and livestock. These particles can be directly released when coal, gasoline, diesel fuels and wood are burned. Many fine particles are also formed in the atmosphere from chemical reactions of nitrogen oxides, sulfur oxides, organic compounds and ammonia. Fine particulates are associated with increased hospitalizations and deaths due to respiratory and heart disease and can worsen the symptoms of asthma. People with respiratory or heart disease, the elderly and children are the groups most at risk. Fine particles are also major contributors to reduced visibility (haze).

Carbon monoxide is a colorless, odorless, highly toxic gas emitted from automobiles, trucks and other gas and diesel-powered equipment. In small amounts it can impair alertness, cause fatigue and headaches. In large amounts it can be fatal. People with heart conditions are most at risk.

Pollutants can be man-made, like smog or particle pollution, but it can also come from trees, plants and flowers. An estimated 67 million Americans suffer from allergies. An allergy is a heightened sensitivity to a foreign substance (called an allergen) which causes the body's defense system (the immune system) to overreact when defending itself. Normally, the immune system would only react if a harmful substance, such as a bacteria, attacks the body. For people with allergies, their own immune system is working too hard, and it reacts even when relatively harmless substances such as pollen are present. The severity of an allergic reaction can vary from mild discomfort to life threatening situations. Allergens can stimulate an immune response when you breathe in or touch the allergen, or by ingestion of food or beverage, or from injections of medication. People suffering from hay fever and asthma can have an allergic reaction, especially when atmospheric conditions concentrate pollen near the ground. The result can be a combination of the following symptoms: sneezing, wheezing, nasal congestion, coughing, itchy eyes, stomachache, and itchy skin. Since pollen is sensitive to wind direction, speed and stability of a given air mass, it can be predicted, much like day-to-day weather.

Air quality information 804 is vitally important to people suffering from respiratory and heart ailments, athletes who train outside, infants and small children, and millions of Americans who have asthma. Under certain conditions, most notably an “inversion” (warm air aloft trapping pollutants near the ground) coupled with light winds can create ripe conditions for air quality problems: pollutants can build up and conditions can make it difficult for high-risk people to be outside. The air quality information 804 can be made available for people who are mobile, and checking air quality information on their cell phones or other mobile telecommunications device. An air quality chart used to display health effects of poor air quality is disclosed in Table 1.

TABLE 1
Air Quality Health Effects

| | | Carbon | | Particulate Matter |
|---|---|---|---|---|
| | Ozone | Monoxide | Sulfur Dioxide | PM-2.5 |
| Categories | 8-hour | 8-hour | 24-hour | 24-hour |
| Good | None | None | None | None |
| (green) | | | | |
| Moderate | Unusually | None | None | Respiratory symptoms |
| (yellow) | sensitive | | | possible in unusually |
| | individuals may | | | sensitive individuals, |
| | experience | | | possible aggravation |
| | respiratory | | | of heart or lung |
| | symptoms. | | | disease in people with |
| | | | | cardiopulmonary |
| | | | | disease and older |
| | | | | adults. |
| Unhealthy | Increasing | Increasing | Increasing | Increasing likelihood |
| for Sensitive | likelihood of | likelihood of | likelihood of | of respiratory |
| Groups | respiratory | reduced | respiratory | symptoms in sensitive |
| (orange) | symptoms and | exercise | symptoms, such | individuals, |
| | breathing | tolerance due to | as chest | aggravation of heart or |
| | discomfort in | increased | tightness and | lung disease and |
| | active children | cardiovascular | breathing | premature mortality in |
| | and adults and | symptoms, such | discomfort, in | persons with |
| | people with | as chest pain, in | people with | cardiopulmonary |
| | respiratory | people with | asthma. | disease and the |
| | disease, such as | cardiovascular | | elderly. |
| | asthma. | disease. | | |
| Unhealthy | Greater likelihood | Reduced | Increased | Increased aggravation |
| (red) | of respiratory | exercise | respiratory | of heart or lung |
| | symptoms and | tolerance due to | symptoms, such | disease and |
| | breathing difficulty | increased | as chest | premature mortality in |
| | in active children | cardiovascular | tightness and | persons with |
| | and adults and | symptoms, such | wheezing, in | cardiopulmonary |
| | people with | as chest pain, in | people with | disease and the |
| | respiratory | people with | asthma; possible | elderly; increased |
| | disease, such as | cardiovascular | aggravation of | respiratory effects in |
| | asthma; possible | disease. | heart or lung | general population. |
| | respiratory effects | | disease. | |
| | in general | | | |
| | population. | | | |
| Very | Increasingly | Significant | Significant | Significant |
| Unhealthy | severe symptoms | aggravation of | increase in | aggravation of heart or |
| (deep red/ | and impaired | cardiovascular | respiratory | lung disease and |
| brown) | breathing likely in | symptoms, such | symptoms, such | premature mortality in |
| | active children | as chest pain, in | as wheezing and | persons with |
| | and adults and | people with | shortness of | cardiopulmonary |
| | people with | cardiovascular | breath, in people | disease and the |
| | respiratory | disease. | with asthma; | elderly; significant |
| | disease, such as | | aggravation of | increase in respiratory |
| | asthma; | | heart or lung | effects in general |
| | increasing | | disease. | population. |
| | likelihood of | | | |
| | respiratory effects | | | |
| | in general | | | |
| | population. | | | |

The levels, including color, can be incorporated in the AQI sent to the geotemporal information server 802 for transmission to a mobile device at a particular location as previously described.

Snowfall information 806 can be incorporated in the geotemporal information server 802 such that the information 806 includes actual or forecast snowfall data to the weather data. Snowfall information 806 can consist of current snow cover, predicted snowfall, or historical snowfall. Current snow cover refers to snow on the ground, reported by official National Weather Service recording stations every morning at 7 am local time. Predicted snowfall for a given location refers to the predictions, down to the inch, that are usually issued within 24 hours of the expected onset of a storm. Regarding historic snowfall, a need may arise for how much snow was on the ground in a given city on a given day. This data is archived by local National Weather Service offices nationwide and the NCDC, the National Climatic Data Center, in Asheville, N.C.

Ultraviolet radiation information 808 can be incorporated into the weather data held by the geotemporal information server 802. The information 808 may be represented as a UV Index on a 1-11+ scale that is assigned to represent to consumers a quick estimate of the sun's potentially harmful effects. The sun's ability to trigger not only painful sunburns but skin cancer has been widely researched and documented, yet every year tens of millions of Americans sunbathe, often with little or no protection from sun screen.

The ozone layer shields the Earth from harmful UV radiation. Ozone depletion, as well as seasonal and weather variations, cause different amounts of UV radiation to reach the Earth at any given time. Developed by the National Weather Service (NWS) and EPA, the UV Index predicts the next day's ultraviolet radiation levels on a 1-11+ scale, helping people determine appropriate sun-protective behaviors. Guidelines for reporting the UV Index have been revised according to guidance from the World Health Organization, and a daily forecast if issued by the EPA, for specific zip codes nationwide. In the United States, the UV Index is computed using forecasted ozone levels, a computer model that relates ozone levels to UV incidence (incoming radiation level) on the ground, forecasted cloud amounts, and the elevation of the forecast cities. Certain other countries also use ground observations.

The calculation starts with measurements of current total ozone amounts for the entire globe, obtained via two satellites operated by the National Oceanic and Atmospheric Administration (NOAA). These data are then used to produce a forecast of ozone levels for the next day at various points around the country. A model is then used to determine the amount of UV radiation reaching the ground from 290 to 400 nm in wavelength (representing the full spectrum of UV wavelengths), using the time of day (solar noon), day of year, and latitude. This information is then weighted according to how human skin responds to each wavelength; it is more important to protect people from wavelengths that harm skin than from wavelengths that do not damage people's skin. The weighting function is called the McKinlay-Diffey Erythema action spectrum. These weighted irradiances are totaled, or integrated, over the 290 to 400 nm range resulting in a value representing the total effect a given day's UV radiation will have on skin. These estimates are then adjusted for the effects of elevation and clouds. UV at the surface increases about 6% per kilometer above sea level. Clear skies allow 100% of the incoming UV radiation from the sun to reach the surface, whereas scattered clouds transmit 89%, broken clouds transmit 73%, and overcast conditions transmit 31%. Once adjusted for elevation and clouds, this value is then scaled (divided) by a conversion factor of 25 and rounded to the nearest whole number. This results in a number that usually ranges from 0 (where there is no sun light) to the mid teens. This value is the UV Index. Thus, the UV Index for the example city would be:
309.5/25=12.4, rounded to 12

The computation of the UV Index may or may not include the effects of variable surface reflection (e.g., sand, water, or snow), atmospheric pollutants or haze. Such computations could be incorporated into or excluded from the UV Index and/or the ultraviolet radiation information 808 consistently with the present disclosure. Table 2 shows the UV Index as categorized by the World Health Organization:

TABLE 2

| UVI | Exposure Level |
|---|---|
| 0, 1, 2 | Low |
| 3, 4, 5, | Moderate |
| 6, 7, | High |
| 8, 9, 10 | Very High |
| 11 and greater | Extreme |

Additional extended outlook information 810 incorporated in the geotemporal information server 802 can increase the forecast weather data from a 7 day to a 15 day or more forecast. Numerical weather prediction (ie. using computer simulations of the atmosphere to predict future weather for a given time and place) has some skill (defined as better than a 50% accuracy rate) out to 14 days. Beyond 2 weeks computer models have little or no skill in predicting specific temperature and precipitation for a specific point on the globe. Accuracy drops off with time, the result of many factors. Incomplete data is “initialized” into the computer models, and the current physics used in computer simulations, or models, is still an imperfect estimate of how the atmosphere really works. Even so, users want to make plans days, even weeks into the future. An Extended Outlook can help them make plans with a higher degree of confidence.

A past weather compilation 812 can be incorporated in the geotemporal information server 802 to display times and amounts of past rain, snow or other weather events. Weather is chronological; it has a past, current and future. Users of weather information are often interested in what happened on a previous day, from a previous storm. This may be for a variety of reasons: insurance or litigation matters pertaining to storm damage, the desire to see if weather was a factor in a car or household accident, and the ability to spot trends in the weather data (is the weather becoming wetter, drier, more humid, etc.). Weather data for thousands of reporting stations is continually archived and available in the public domain, so users can access past weather including cloud cover, precipitation, wind speed and direction, temperature and humidity levels for a given day and location.

The past weather compilation 812 may include a severe weather compilation. A Storm Prediction Center (SPC) archives severe weather reports dating back to 1999, and these can be made available to users of the system disclosed. A severe storm is defined as a 1). Tornado, 2). Flood. 3). Straight-line wind over 58 mph, and/or 4). Hail ¾″ (quarter-size) or larger. Generally severe weather is capable of endangering human life and/or triggering property damage. The past weather compilation 804, through usage of the SPC, may allow users to call up past reports of severe weather, and plot the location and text-specifics of that storm on a geo-located map, allowing those users to determine if a specific storm impacted one of their locations.

A forecast user interface 814 can be incorporated to provide navigation of the aforementioned options related to weather output in the geo-temporal information server. Weather information is tailored for a specific town or zip code, and the available information is navigable by manipulating keys on a mobile telecommunications device, such as the up, down, left, and right buttons of a cellular telephone.

For example, current condition data is displayed in graphical and text form from the nearest METAR site, with new updates available close to the top of each hour. An almanac summary can include National Weather Service data, displaying the record high (and year), record low (and year), normal high and low temperature, and sunrise/sunset information for that location. Location data can indicate where the latest weather observation was taken, and how far this METAR site is from the location chosen. A text version of the National Weather Service forecast (updated 3-4 times daily) may also be included. Hourly forecasts for a given location, with predicted sky, temperature, wind direction and speed are included as well. This data comes from a variety of computer models from the National Weather Service. Furthermore, a 7-Day extended outlook, with sky conditions in icon/graphic as well as text form, and a predicted high and low temperature for each day, going out 7 days are incorporated. Such information may be received from the National Weather Service, interpolated for that particular location and latitude/longitude.

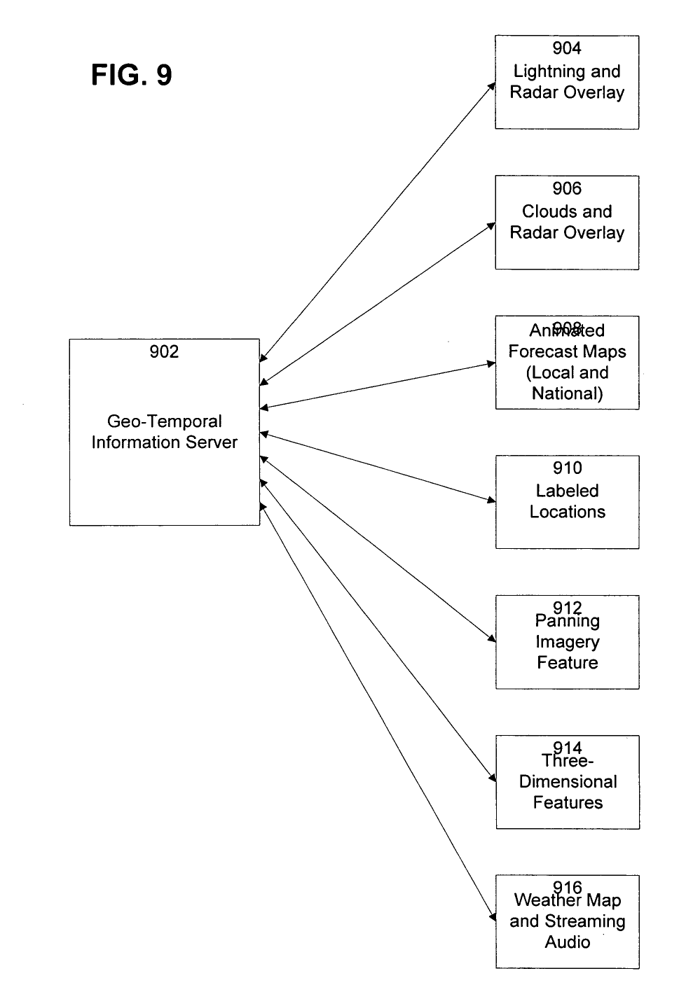

Referring to FIG. 9, a feature diagram 900 of a geo-temporal information server 902 incorporating graphical features is disclosed according to an embodiment of the disclosure. The graphical features include a lightning and radar overlay 904, a clouds and radar overlay 906, an animated forecast map 908, labeled locations 910, a panning imagery feature 912, three-dimensional features 914, and a weather map with streaming audio 916.

The lightning and radar overlay 904 may display a looping image showing radar data and individual lightning strikes overlaid. Lightning is the number-one cause of storm-related deaths in the United States. Lightning affects all regions. Florida, Michigan, Pennsylvania, North Carolina, New York, Ohio, Texas, Tennessee, Georgia, and Colorado have the most lightning deaths and injuries. Damage costs from lightning are estimated at $4-5 billion each year in the U.S. There are approximately 100,000 thunderstorms in the U.S. each year. Americans are twice as likely to die from lightning than from a hurricane, tornado or flood. The Federal Emergency Management Agency (FEMA) estimates there are 200 deaths and 750 severe injuries from lightning each year in the United States 20% of all lightning victims die from the strike. 70% of survivors will suffer serious long-term effects. Annually, there are more than 10,000 forest fires caused by lightning.

Because of such severe consequences, it is often helpful and advantageous for the consumer to have the option of overlaying lightning strike data onto a radar display. Radar shows intensity of precipitation, rain and snow, but it is often impossible to determine which parts of a storm are intense enough to be generating dangerous lightning. By viewing such an overlay 904, the user can not only see where it is raining, but how close potentially life-threatening lightning strikes are to one of their preset locations, or their current, GPS-enabled realtime position. Most people are struck by lightning at the beginning or end of a storm. Just because heavy rain is over does not mean that the lightning risk has passed. Generally, experts advise waiting at least 30 minutes after the last audible thunderclap before resuming outdoor activities, to increase one's safety margin. The ability to check up to the minute radar and lightning displays should give consumers more accurate and reliable information with which they can make better choices and decisions in an effort to reduce the threat of lightning-related injury and death. The lightning strikes on the overlay 904 may be color-coded based on how recently the lightning strike occurred.

The clouds and radar overlay 906 can display a looping image showing radar data and satellite imagery overlaid. Consumers may desire cloud information, and this data comes from NOAA Weather Satellites 22,300 miles above the equator, transmitting visible and infrared radiation images of cloudcover every 30 minutes, 24 hours a day. For instance, someone at the beach or on a boat might want to know how long the sun will stay out. It is usually impossible to tell from a satellite “birds-eye perspective” which clouds are thick enough to produce rain. By overlaying radar data on top of clouds the consumer of weather information can not only see where clouds are increasing, but which clouds, specifically, are generating rain, snow or ice. To accomplish the overlay 906, the radar data and satellite imagery may be coordinated to display as observed or measured at the same time.

The animated forecast map 908 can display weather data animated into the future. The weather data commonly includes temperature, precipitation, and cloud forecasts. The goal of the animated forecast map 908 is to present a concise, colorful and useful summary of a predicted day's weather onto the small screen of a cellular phone. Users of weather information specifically care about temperature and precipitation information. Users often ask questions such as: How warm will it be? Warm enough for shorts and t-shirts, or will jackets be required? Will it rain for my outdoor event, or will it be cold enough for a mix of ice or snow? Will traffic and my commute be impacted? The animated forecast map can assist in providing a user with this information.

Computer model data is analyzed with high temperature, low temperature, and daily weather information presented to a user. High temperatures usually occur during the mid or late afternoon hours, from 3 pm to 6 pm, on a given day. Low temperatures for a given day usually come within 30 minutes of sunrise. The daily weather information displays to a user whether it will be sunny, partly sunny, raining, snowing, or cloudy. The animated forecast map 908 can provide an average sky for a given day, a summary of what the majority of the day's weather will be for that location. Of course, other weather data may be included.

The labeled locations 910 can appear on the displayed map sent from the geo-temporal information server 902. The locations 910 may include the current location of a wireless telecommunications device (as in FIG. 1, above), or other locations entered by a user of the device. For example, if a cellular phone user is equipped with a GPS-enabled device, it may be possible to automatically center the location of the user, and always have the user at the CENTER of the cell phone screen. At other times it will be useful to label the locations already defined by the user, like “home”, “office”, “boat”, “cabin”, etc. It is important for the user to see where their pre-stored locations are in relation to current weather, be it radar, severe storm locations, lightning strikes, or other weather to assess the threat level, and what if any action needs to be taken by the user to protect life and property.

The panning imagery feature 912 may allow the user to pan around looping imagery or a weather map. It is often useful and important for the user to be able to get the “big picture” and manipulate data on the screen. For instance, the consumer of weather may want to “pan west”, or force the screen to the left, to get a better look at a line of thunderstorm approaching. Weather systems can move as quickly as 40 to 60 mph. and the ability to pan around the weather map is critical when assessing an ongoing weather threat; therefore such a panning feature is valuable to a user. To incorporate the panning feature 912, more data is sent, as necessary, from the geo-temporal information server 902 to the telecommunications device to provide for this panning feature.

The three-dimensional features 914 may include clouds, radar, and a weather map. The lower atmosphere “Troposphere”, where most of the “weather” as commonly referred to takes place, extends some 15 miles above the ground. It is useful to display weather in 3 dimensions, to give users a more realistic and accurate portrayal of the weather affecting their locations. For example: fog is shallow, usually no more than a few hundred feet thick. It may look white from satellites in outer space, but it is an entirely different phenomenon from a thunderstorm, which may tower 12-14 miles into the atmosphere. Giving the user the ability to navigate 3 dimensions will allow him or her to distinguish fog from towering, column-like thunderheads, and also determine which sections of a storm, which altitudes, are most severe or intense. Nexrad Doppler Radar data from the National Weather Service arrives in different “slices”, from 0.5 to 2.5 degrees of elevation above the ground. These featuers 914 can be displayed vertically, so users can determine which thunderstorms are most dangerous. Satellite data from NOAA Weather Satellites assigns a specific color to a specific temperature. Low (warm) clouds will appear different (displayed as a dark gray) than thunderstorm anvils, which protrude 8-12 miles into the atmosphere and are very cold, appearing as a bright white on the display. Giving users a birds-eye, “Space Shuttle” view of weather unfolding below allows users to assess the severity of the systems displayed. Such three-dimensional features 914 may be incorporated into a map navigable about three axes.

The weather map with streaming audio 916 can coordinate a weather map or animated weather map with audio describing the weather events or forecast information shown. This feature is directed to users of weather services accustomed to watching weather reports on television and listening on radio. There is often a weather narrative in such broadcasts, with a beginning, middle and end. Past weather is reported, then current weather, followed by a prediction of future weather for a specific viewing area. The present disclosure personalizes this process, so that users living in different towns will receive an audio stream customized to their specific location or locations, rather than an “average” forecast for a metropolitan area that may cover thousands of square miles. A weather map functionality will display everything from current temperatures, humidity levels and wind speed and direction, along with the option of visibility, “weather” (rain, snow, fog, etc, in text form) and other user-selectable parameters of interest. The user's locations are displayed for perspective. While the user is watching an automatic progression of weather maps, complete with their locations of interest labeled for easy reference, they will hear an audio stream that is specific to the location they have chosen.

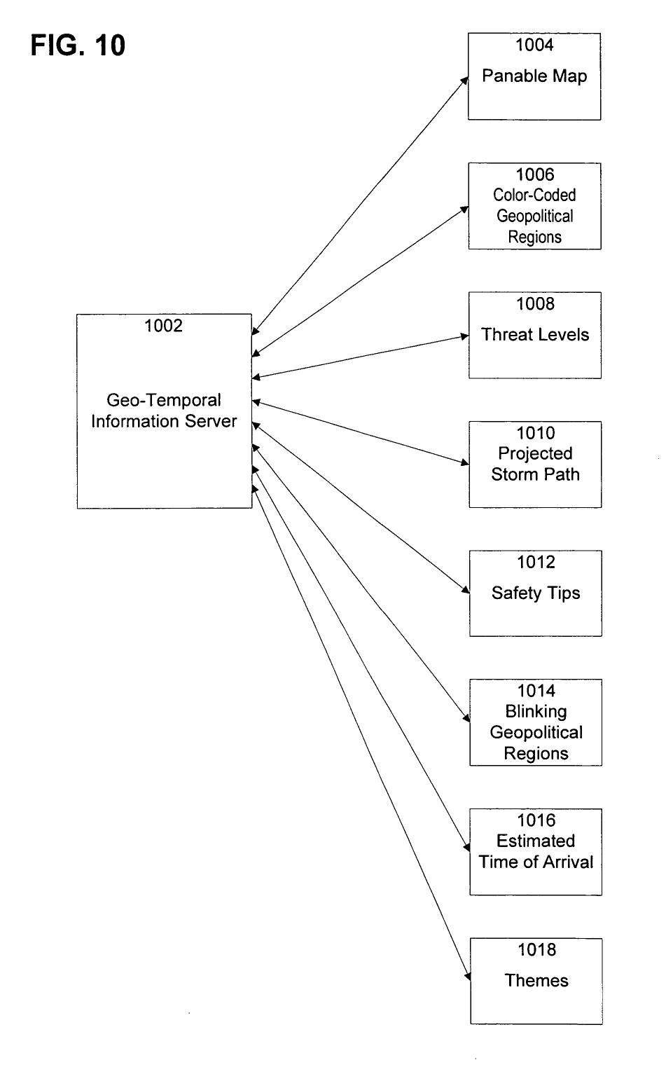

Referring to FIG. 10, a feature diagram 1000 of a geo-temporal information server 1002 incorporating storm watch features is disclosed according to an embodiment of the disclosure. The storm watch features can include a panable map 1004, color-coded geopolitical regions 1006, threat levels 1008, a projected storm path 1010, safety tips 1012, blinking geo-political regions 1014, an estimated time of arrival 1016, and one or more themes 1018.

The panable map 1004 can implement a storm watch map. It is often useful and important for the user to be able to get the “big picture” and manipulate data on the screen. For instance, a user of the disclosed system may want to “pan west”, or force the display to show data representing weather and geographical information beyond the left side of the display. This allows the user to get a better look at a line of thunderstorms approaching. Weather systems can move as quickly as 40 to 60 miles per hour, and the ability to pan around the weather map is critical when assessing an ongoing weather threat.

The color-coded geopolitical regions 1006 display cities and political boundaries on the maps sent from the geo-temporal information server 1002. Such regions are important because during a fast-moving severe storm situation scores, even hundreds of warnings can be issued for a specific state. It can be extremely difficult for a consumer to understand the threat level, and recognize how close he or she is to potentially life-threatening weather. In some cases a user may not know the names of nearby counties, and have no idea that severe weather is within striking distance and closing in rapidly. It is helpful to color-code severe storm information, assigning certain colors to specific weather threats with a color-coded key visible on the display of the wireless telecommunications device. For example, a red county may signify a tornado watch. An orange county may signify a severe storm watch. A blinking red county may signify a tornado warning, where a tornado has been spotted by the public or on radar, a much more dangerous scenario for the user. So, at a glance, the user will be able to look at the screen and instantly determine an overall threat assessment regarding how close a watch or warning is to their current location, or their preset locations of interest. Since a warning is more dangerous that a watch, it will be displayed over a watch color. For example, a tornado warning (blinking red) would be given prominence over a tornado watch (glowing constant red) for the same county.

The threat levels 1008 display the level of severity of weather events, such as thunderstorms, tornadoes, or other events requiring such a warning system. A user is able to cycle through warnings related to these threat levels in a list. The National Weather Service issues 3 main types of alerts, based on perceived threat level:

1). Advisory: An advisory is rarely life-threatening. Advisories are issued for everything from minor snow events to fog.

2). Watch: A watch means conditions are ripe for potentially dangerous, life-threatening weather. A watch is often issued for multiple states, lasting anywhere from 6 hours to 24 hours in the case of winter storms. A tornado watch means that tornadoes are possible. A winter storm watch means that 6″ or more of snow is possible within the next 24 hours.

3). Warning: The most important type of weather alert issued by local National Weather Service offices, warnings imply that severe weather has been spotted, and is imminent. Severe storms may be detected on Nexrad Doppler Radar and/or by SKYWARN or law enforcement spotters in the field, looking for signs of severe weather, like rotation of a cloud base, funnel formation, large hail, and cloud signatures associated with severe straight-line winds. Warnings are usually issued on a county-by-county basis.

Additionally, the National Weather Service usually defines a “high threat” area within a county under a warning. In other words, in addition to issuing a warning, the local NWS office defines a parallelogram that shows the projected TRACK of a hailstorm, straight-line wind or tornado.

The threat levels 1008 may alert users to not only warnings issued on a county-by-county basis by local National Weather Service offices, but also may alert a user if he or she is in a “high threat” area, in the direct path of the storm, as defined by the NWS. The threat levels 1008 add additional value for the user wanting to see how close their location or location(s) are to potentially dangerous weather.

The projected storm path 1010 displays an indicator such as an arrow showing the direction of travel of severe weather events. The location of the severe weather event (tornado, hailstorm, straight-line wind, or flood) is critical, but so is the motion of the storm. Severe thunderstorms usually move from southwest to northeast, but they can approach from any direction, stall, or do U-turns on rare occasions. The projected storm path 1010 will determine the high-threat area and the communities and locations that may experience severe weather in the short term. It is essential to display the direction and speed of a storm for users. Again, some tornadic supercell thunderstorms have been known to have a forward speed of up to 60 mph. In contrast, slow-moving thunderstorms can stall over one location, prolonging heavy rain, and increasing the threat of deadly flash flooding. The projected storm path 1008 displays such information.

The safety tips 1012 are messages sent from the geo-temporal information server 1002 to a wireless telecommunications device (as in FIG. 1, above) related to the current or forecast weather. Such tips are valuable because once a warning is issued by the National Weather Service and received on a cell phone, users may be confused about what steps to take next. The system disclosed streams severe storm safety tips that take some of the mystery and fear out of severe weather, explaining where a user should go and what they should do to increase their safety margin and reduce the risk of bodily injury. These safety tips can be tailored for various locales, such as:

a). Home. In general a basement provides the most protection, under the stairwell. Otherwise a small, windowless room on the ground floor, away from windows, works best. When an assigned “home” location is selected in the present system, these messages will appear.

b). Office. It is critical that employees get away from outer walls and windows. A center stairwell or restroom often provides the greatest margin of safety. Again, a user can assign a location as an “office” which will tailor the alert messages accordingly.

c). Store. Big box retailers and malls can present a unique danger, especially from flying glass. It is important to find a basement, or a small room, away from windows and other potential sources of broken or flying glass.

d). Outside. Given enough time, any shelter or building will provide the best sanctuary from approaching lighting or dangerous winds. Otherwise, crouching down in a small grove of shrubs, not lying flat on the ground, is the best way to ride out a severe storm.

e). Vehicle. Cars and trucks can become airborne when winds top 100 mph. It is critical for people in their vehicles to get out and go into a nearby ditch, if no shelter is available nearby.

Of course, other locations can be incorporated consistent with the present disclosure.

The blinking geo-political regions 1014 are counties or other areas. The regions blink if severe weather is currently occurring or forecast for that area. During a fast-moving severe storm situation, hundreds of warnings can be issued for a specific state. It can be extremely difficult for a consumer to understand the threat level, and how close he or she is to potentially life-threatening weather. In some cases a consumer may not know the names of nearby counties, and have no idea that severe weather is within striking distance. It can be helpful to color-code severe storm information, assigning certain colors to specific weather threats. In other words, a red county can signify a tornado watch. An orange county can signify a severe storm watch. A blinking red county can signify a tornado warning, where a tornado has been spotted by the public or on radar, a much more dangerous scenario for the consumer. So, at a glance, the user will be able to look at the screen and instantly determine how close a watch or warning is to their current location or their preset locations of interest.

The estimated time of arrival 1016 indicates the time a severe weather event is projected to reach a selected location. Once it is determined where severe weather is occurring, and the speed and direction of the storm, it is then possible to track the future arrival time of wind, flooding, hail or lightning, and display an ETA, or Estimated Time of Arrival, for specific towns and locations in the path of the storm. Although just a rough estimate, plotting the ETA of a severe weather event on a cell phone for a specific user-defined location (or current location on GPS-enabled cell phones) allows the user to gauge the threat level, and how quickly they should take evasive action and move to a safer location. For example, the estimated time of arrival 1016 may relate to the time a thunderstorm will reach a city or the current location of the mobile telecommunications device.

One or more themes 1018 may be incorporated into the system 1000 to provide the look and feel of the system as displayed on a mobile telecommunications device. Whenever a user sets or changes his or her location, the system 1000 immediately downloads themes 1018 for that location. The theme 1018 is based on the current weather condition for that location. (ie. temperature or precipitation are the 2 most logical weather parameters to base themes on). Themes may consist of various pieces of artwork and a definition of various colors. The client uses these as various backgrounds, borders, text colors, and adornments, as a way of “dressing up” the screen and tying look and feel to the current weather for that location. A specific theme could also be based on the season of the year, a current holiday, or even be specific to a particular location. (E.g. cherry blossoms in the District of Columbia). The user has the option of turning the theme option on or off.

One of skill in the art will readily appreciate that the names of the methods and properties are not intended to limit the invention. Furthermore, additional methods and properties can be added to the objects, functions can be rearranged among the objects, and new objects to correspond to future enhancements and physical devices used in the disclosure can be introduced without departing from the scope of the invention. One of skill in the art will readily recognize that the disclosure can be applicable to future communication devices, different file systems, and new data types.

The above specification, examples and data provide a complete description of the manufacture and use of the composition of the invention. Since many embodiments of the disclosure can be made without departing from the spirit and scope of the invention, the invention resides in the claims hereinafter appended.

1. A geo-temporal information system comprising:
(a) a mobile telecommunications device including a display, the telecommunications device wirelessly connected to a geo-temporal information server containing geo-temporal information;
(b) at least one map stored on the geo-temporal information server, the map configured to present geographical information on the display and representing a geographical area including at least one particular location; and
(c) at least one user-customized subset of the geo-temporal information received from the geo-temporal information server, the user-customized subset representing types of geo-temporal events occurring at an event time and an event location, wherein the user-customized subsets are presented as graphical data on the display concurrently with the map.

2. The geo-temporal information display system of claim 1, wherein the particular location is the current location of the mobile telecommunications device.

3. The geo-temporal information display system of claim 1, wherein the particular location is based on periodic updating of the location of the mobile telecommunications device.

4. The geo-temporal information display system of claim 1, wherein the particular location is a previous user-selected particular location of the mobile telecommunications device.

5. The geo-temporal information display system of claim 1, wherein the particular location is a user-selectable location chosen from among locations represented by the map.

6. The geo-temporal information display system of claim 1, wherein the user-customized subset of geo-temporal information comprises lightning time and location data.

7. The geo-temporal information display system of claim 1, wherein the user-customized subset of geo-temporal information comprises ultraviolet radiation level data.

8. The geo-temporal information display system of claim 1, wherein the user-customized subset of geo-temporal information comprises rainstorm location and severity information.

9. The geo-temporal information display system of claim 1, wherein the user-customized subset of geo-temporal information comprises snow depth and location information.

10. The geo-temporal information display system of claim 1, wherein the user-customized subset of geo-temporal information comprises historical weather information.

11. The geo-temporal information display system of claim 1, wherein the user-customized subset of geo-temporal information is user-selectable.

12. The geo-temporal information display system of claim 1, wherein the mobile information device is a cellular telephone.

13. The geo-temporal information display system of claim 1, wherein the mobile information device is a personal digital assistant.

14. The geo-temporal information display system of claim 1, wherein the user-customized subset of geo-temporal information comprises forecast information.

15. The geo-temporal information display system of claim 1, wherein the geo-temporal information display system further comprises pre-recorded audio weather messages.

16. The geo-temporal information display system of claim 1, wherein the user-selectable subset comprises a changed visual appearance assigned to at least one region of the map corresponding to a severity of geo-temporal events in a corresponding geographical region.

17. The geo-temporal information display system of claim 1, wherein the server assigns a changed visual appearance to at least one region of the map corresponding to a severity of threat of weather events in a corresponding geographical region.

18. The geo-temporal information display system of claim 17, wherein the display system further comprises estimated time of arrival data related to the geo-temporal events and the particular location.

19. The geo-temporal information display system of claim 17, wherein the display system further comprises projected path of travel data related to the geo-temporal events.

20. The geo-temporal information display system of claim 1, wherein the map is three-dimensional.

21. The geo-temporal information display system of claim 1, wherein the map is navigable.

22. A method of displaying geo-temporal information, the method comprising:
selecting at least one user-customized subset of geo-temporal information stored on a geo-temporal information server;
generating a request for geo-temporal information associated with a particular location of a mobile telecommunications device having a display;
receiving a map configured to present geographical information on the display, the map comprising a graphical representation of the particular location;
receiving the user-customized subset of geo-temporal information on the mobile telecommunications device; and
presenting the user-customized subset of geo-temporal information and the map on the display of the mobile telecommunications device.

23. The method of claim 22 further comprising determining a location of the mobile telecommunications device.

24. The method of claim 22 wherein the particular location comprises the current location of the mobile telecommunications device.

25. The method of claim 22 wherein the mobile telecommunications device comprises a cellular telephone.

26. The method of claim 22 wherein the user-customized subset of geo-temporal information is user-selectable.

27. In a mobile telecommunications device having a graphical user interface including a display and a user interface selection device, a method of displaying geo-temporal information, comprising the steps of:
selecting at least one user-customized subset of geo-temporal information stored on a geo-temporal information server for display;
generating a request for geo-temporal information associated with the particular location of the mobile telecommunications device;
receiving a map configured to present geographical information on the display, the map and comprising a graphical representation of the particular location;
receiving the user-customized subset of geo-temporal information on the mobile telecommunications device; and
presenting the user-customized subset of geo-temporal information and the map on the display of the mobile telecommunications device.

28. The method of claim 27 further comprising determining a particular location of the mobile telecommunications device;

29. The method of claim 27 wherein the particular location comprises the current location of the mobile telecommunications device.

30. The method of claim 27 wherein the particular location comprises a projected future location of the mobile telecommunications device.

31. The method of claim 27 wherein the mobile telecommunications device comprises a cellular telephone.

32. The method of claim 27 wherein the user-customized subset of geo-temporal information is user-selectable.

33. The method of claim 27 wherein the map is navigable.

34. The method of claim 27 wherein the user-customized subset of geo-temporal information represents a time-lapse animation of geo-temporal events.

35. The method of claim 34 wherein the displaying repeats one or more times.

36. The method of claim 27 wherein the displaying further shows location information.

37. An emergency weather event graphical display system comprising:
(a) a mobile telecommunications device comprising a display, the telecommunications device residing at a current location and wirelessly connected to a weather information server containing emergency weather event information representing emergency weather events that have occurred within a predetermined time;
(b) at least one map stored on the weather information server, the map configured to present geographical information on the display and representing a geographical area including the current location; and
(c) first and second graphical objects configured for display on the map, the first graphical objects representing recent emergency weather events and the second graphical objects representing historical weather events;
(d) wherein the emergency weather event information is received by the mobile telecommunications device and presented as graphical data on the display within a predetermined temporal proximity to the weather events that occur within a predetermined proximity to the current location.

38. The weather event graphical display system of claim 37, wherein the mobile telecommunications device periodically transmits current location data to the weather information server.

39. The weather event graphical display system of claim 37, wherein the emergency weather event information comprises lightning information.

40. The weather event graphical display system of claim 37, wherein the emergency weather event information comprises tornado information.

41. The weather event graphical display system of claim 37, wherein the emergency weather event information comprises hurricane information.

42. The weather event graphical display system of claim 37, wherein the emergency weather event graphical display system further comprises weather tips presented on the display concurrently with the weather event information.

43. A method of displaying server-generated lightning alerts, the method comprising:
determining a current location of a mobile telecommunications device having a display;
receiving on the mobile telecommunications device a lightning alert generated by a weather information server, the lightning alert corresponding to at least one lightning event within a predetermined proximity to the current location; and
presenting a lightning message on the display.

44. The method of claim 43 wherein the mobile telecommunications device is a personal digital assistant.

45. The method of claim 43 wherein the mobile telecommunications device is a cellular telephone.

46. The method of claim 43 wherein the lightning message comprises a distance between the lightning event and the current location and a description of the lightning alert.

47. The method of claim 43 wherein the lightning message comprises a lightning-signifying graphical object.

48. The method of claim 43 wherein the lightning message comprises first and second graphical objects, the first graphical objects representing recent lightning strikes and the second graphical objects representing historical lightning strikes.

49. The method of claim 43 wherein the lightning message further comprises a link to corresponding weather information.

50. The method of claim 49 wherein the lightning message is overlaid on a map containing the corresponding weather information.

51. The method of claim 50 wherein the corresponding weather information is a radar image.

52. The method of claim 50 wherein the corresponding weather information is a satellite image.

53. The method of claim 43 wherein the determining step comprises triangulation among at least three telecommunications sources.

54. The method of claim 43 wherein the determining step utilizes the global positioning system.

55. A current weather monitor for a mobile telecommunications device, the display comprising:
(a) a mobile telecommunications device comprising a color display;
(b) a selected graphic presented on the display; and
(c) an icon incorporated in the selected graphic, the icon comprising a region of the display presenting a current temperature and a weather status indicator denoting the existence of a current weather warning.

56. The current weather display of claim 55, wherein the region comprising the visual state changes colors to denote the existence of a current weather warning.

57. The current weather display of claim 55, wherein the mobile telecommunications device is a cellular phone.

58. The current weather display of claim 57, wherein the selected graphic is a main options menu.

59. The current weather display of claim 57, wherein the display is the secondary display of a folding cellular phone.
